(19) United States
(12) Patent Application Publication
(10) Pub. No.: US 2021/0319064 A1
(43) Pub. Date: Oct. 14, 2021

(54) METHOD AND APPARATUS FOR PROVIDING STORYTELLING DATA

(71) Applicant: CoreDotToday, Inc., Ulsan Metropolitan City (KR)

(72) Inventors: Kyung Hoon KIM, Ulsan (KR); Bong Soo JANG, Ulsan (KR)

(21) Appl. No.: 16/884,481

(22) Filed: May 27, 2020

(30) Foreign Application Priority Data
Apr. 10, 2020 (KR) 10-2020-0044157

(51) Int. Cl. G06F 16/9038; G06F 16/906; G06F 9/455; G06F 16/955; G06F 9/54

(52) U.S. Cl. CPC G06F 16/9038; G06F 16/906; G06F 2009/45587; G06F 16/9566; G06F 9/543; G06F 9/45558

(57) ABSTRACT

The method of providing storytelling data, performed by the storytelling data providing apparatus, includes: receiving a message requesting an application programming interface (API) and system resources from a storytelling data creating terminal; generating a virtual machine according to the system resources; adding the API to the virtual machine and configuring pre-collected big data to be accessible to the virtual machine; obtaining primary processed data from the storytelling data creating terminal; generating machine-processed data by processing the primary processed data by using a storytelling processing machine; and providing the machine-processed data to the storytelling data creating terminal, and obtaining storytelling data generated based on the machine-processed data from the storytelling data creating terminal.

### BACKGROUND OF THE INVENTION

### Field of Invention

The present disclosure relates to a method and apparatus for providing storytelling data, and more particularly to a method and apparatus for processing big data in a storytelling-based manner and sharing the processed data.

### Description of Related Art

As access to communication networks through personal computers (PC) or mobile devices has become daily life, a big data environment becomes common, in which a multitude of persons create more information than humans could ever have imagined in a network space. Big data refers to data which grows beyond the scale, has a short generation period, and includes both text and images in terms of data form.

As this big data environment becomes more and more common, the importance of a technique of processing and reproducing data accessible in multiple paths as well as data production is increasing. Among various types of data, storytelling data boasts of high utilization because processed information of the storytelling data is easily understandable and accessible to any users

However, creation or processing of storytelling data from big data depends dominantly on the capability of an entity responsible for the behavior and a data collection method. Accordingly, there is a need for a method of enabling any user to create and process storytelling data and share the processed data with many other users.

### BRIEF SUMMARY OF THE INVENTION

Therefore, the present disclosure has been made in view of the above problems, and it is an object of the present disclosure to provide a method of providing storytelling data.

It is another object of the present disclosure to provide an apparatus for providing storytelling data.

To achieve the above objects, an aspect of the present disclosure provides a method of providing storytelling data, performed by a storytelling data providing apparatus.

A method of providing storytelling data, performed by a storytelling data providing apparatus, may include receiving a message requesting an application programming interface (API) and system resources from a storytelling data creating terminal, generating a virtual machine according to the system resources, adding the API to the virtual machine and configuring pre-collected big data to be accessible to the virtual machine, obtaining primary processed data from the storytelling data creating terminal, generating machine-processed data by processing the primary processed data by using a storytelling processing machine, and providing the machine-processed data to the storytelling data creating terminal, and obtaining storytelling data generated based on the machine-processed data from the storytelling data creating terminal.

The method of providing storytelling data may further include converting the storytelling data to a format openable by a known application, and generating a uniform resource locator (URL) accessible for the converted storytelling data.

The method of providing storytelling data may further include, after the generation of the URL accessible for the converted storytelling data, receiving a message requesting access from a storytelling data consuming terminal, performing user authentication for the storytelling data consuming terminal, and encrypting the URL and providing the encrypted URL to the storytelling data consuming terminal, in response to completion of the user authentication.

The virtual machine may be Jupyter Notebook being a Python-based development tool.

The storytelling data may be a single document having ipynb as an extension.

To achieve the above objects, another aspect of the present disclosure may provide an apparatus for providing storytelling data.

The apparatus for providing storytelling data may include at least one processor, and a memory storing instructions instructing the at least one processor to perform at least one step.

The at least one step may include receiving a message requesting an API and system resources from a storytelling data creating terminal, generating a virtual machine according to the system resources, adding the API to the virtual machine and configuring pre-collected big data to be accessible to the virtual machine, obtaining primary processed data from the storytelling data creating terminal, generating machine-processed data by processing the primary processed data by using a storytelling processing machine, and providing the machine-processed data to the storytelling data creating terminal, and obtaining storytelling data generated based on the machine-processed data from the storytelling data creating terminal.

The at least one step may further include converting the storytelling data to a format openable by a known application, and generating a URL accessible for the converted storytelling data.

After the generation of the URL accessible for the converted storytelling data, the at least one step may further include receiving a message requesting access from a storytelling data consuming terminal, performing user authentication for the storytelling data consuming terminal, and encrypting the URL and providing the encrypted URL to the storytelling data consuming terminal, in response to completion of the user authentication.

The virtual machine may be Jupyter Notebook being a Python-based development tool.

The storytelling processing machine may perform, by using the at least one processor, the steps of generating a hypergraph model based on the primary processed data, and generating the machine-processed data by repeating a process of re-configuring the hypergraph model.

The use of the method and apparatus for providing storytelling data according to the present disclosure may facilitate any one to create storytelling data and share the created storytelling data.

Particularly, because optimized machine-processed data is generated from primary processed data created by a creator based on correlations between images and text and provided to the creator, the creator may advantageously generate storytelling data very easily.

### BRIEF DESCRIPTION OF THE DRAWINGS

FIG. 1 is a conceptual view illustrating a method of providing storytelling data according to an embodiment of the present disclosure.

FIG. 2 is a conceptual view partially illustrating an operational relationship between a storytelling data creating terminal and a storytelling data providing apparatus illustrated in FIG. 1.

FIG. 3 is a conceptual view illustrating functional blocks of the storytelling data providing apparatus illustrated in FIG. 1.

FIG. 4 is an exemplary diagram illustrating a user interface provided by the storytelling data providing apparatus illustrated in FIG. 1.

FIG. 5 is a flowchart illustrating a process of creating machine-processed data, performed by a storytelling data processing machine illustrated in FIG. 3.

FIG. 6 is a conceptual view illustrating a hypergraph model according to an embodiment of the present disclosure.

FIG. 7 is a block diagram illustrating an exemplary hardware configuration of the storytelling data providing apparatus illustrated in FIG. 1.

### DETAILED DESCRIPTION OF THE INVENTION

The present disclosure may be subject to various modifications and have various embodiments. Specific embodiments of the present disclosure are described with reference to the accompanying drawings. However, the embodiments are not intended to limit the technical scope of the disclosure, and it is to be understood that the present disclosure covers various modifications, equivalents, and alternatives within the scope and spirit of the present disclosure. With regard to the description of the drawings, similar reference numerals may be used to refer to similar elements.

The term as used in the disclosure, first, second, A, or B may be used for the names of various components, not limiting the components. These expressions are used only to distinguish one component from another component. For example, a first component may be referred to as a second component and vice versa without departing from the scope of the disclosure. The term and/or covers a combination of a plurality of related items or any one of the plurality of related items.

When it is said that a component is “connected to” or “coupled with/to” another component, it should be understood that the one component is connected to the other component directly or through any other component. On the other hand, when it is said that a component is “directly connected to” or “directly coupled to” another component, it should be understood that there is no other component between the components.

The terms as used in the disclosure are provided to describe merely specific embodiments, not intended to limit the scope of other embodiments. It is to be understood that singular forms include plural referents unless the context clearly dictates otherwise. In the disclosure, the term “include” or “have” signifies the presence of a feature, a number, a function, an operation, a component, a part, or a combination thereof, not excluding the presence or addition of one or more other features, numbers, functions, operations, components, parts, or a combination thereof.

Unless otherwise defined, the terms including technical or scientific terms used in the disclosure may have the same meanings as generally understood by those skilled in the art. The terms as generally defined in dictionaries may be interpreted as having the same or similar meanings as or to contextual meanings of related technology. Unless otherwise defined, the terms should not be interpreted as ideally or excessively formal meanings. When needed, even the terms as defined in the disclosure may not be interpreted as excluding embodiments of the disclosure.

Preferred embodiments of the present disclosure will be described below in detail with reference to the attached drawings.

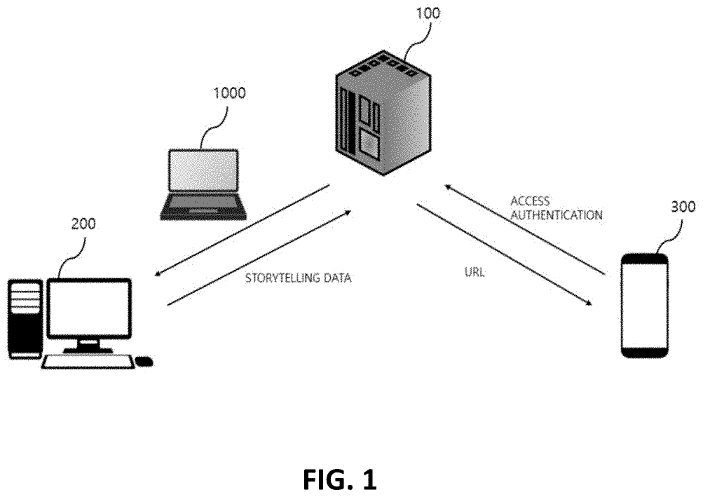

FIG. 1 is a conceptual view illustrating a method of providing storytelling data according to an embodiment of the present disclosure.

Referring to FIG. 1, the method of providing storytelling data according to the embodiment of the present disclosure may be performed by using a storytelling data providing apparatus 100, a storytelling data creating terminal 200, and a storytelling data consuming terminal 300.

The storytelling data providing apparatus 100 may provide a virtual machine 1000 to the storytelling data creating terminal 200 to support the storytelling data creating terminal 200 to create storytelling data through the virtual machine 1000. Further, the storytelling data providing apparatus 100 may configure big data by collecting data from various paths and support the storytelling data creating terminal 200 to access the big data through the virtual machine 1000.

The virtual machine 1000 may be Jupyter Notebook which is a Python-based development tool. The Jupyter Notebook, which is an open source platform enabling parallel computing, provides a Web browser-based interactive shell. The storytelling data creating terminal 200 may combine various objects such as a source code, text, an image, a video, and a mathematic formula into a single document (hereinafter, referred to as a Notebook document) by using the Web browser-based interactive shell provided by the Jupyter Notebook. The Notebook document may be a file having ipynb as an extension. The storytelling data creating terminal 200 may open the Notebook document having the extension ipynb and edit or run a source code by using the Jupyter Notebook.

The Jupyter Notebook may be the virtual machine 1000 enabling editing and running of a source code by an interactive shell provided on a Web browser. Accordingly, the storytelling data creating terminal 200 may check and edit a visualized result by editing and running a source code on the Web browser in real time, and add an application programming interface (API) to the virtual machine 1000 by requesting the storytelling data providing apparatus 100.

The storytelling data providing apparatus 100 may have a Python library, Jupyter embedded therein and provide the virtual machine 1000 to the storytelling data creating terminal 200 in a Web browser environment by using the embedded Jupyter.

The storytelling data providing apparatus 100 may obtain storytelling data from the storytelling data creating terminal 200 and provide the obtained storytelling data to at least one storytelling data consuming terminal 300 in the Web browser-based environment.

The storytelling data is a final product which the storytelling data creating terminal 200 has processed by using big data. The storytelling data may be created by writing the result of analyzing the big data in various forms or manners along a specific storyline. Particularly, the storytelling data may be data obtained by appropriately combining visualized materials (e.g., graphs, charts, and so on) with text following a storyline, rather than a simple enumeration of data. Therefore, the storytelling data may attract much interest and attention from subscribers and be persuasive to the subscribers. The storytelling data may be a single Notebook document having the extension ipynb.

The storytelling data providing apparatus 100 may convert the storytelling data obtained from the storytelling data creating terminal 200 to a format (e.g., html or pdf) openable by a known application, and generate a uniform resource locator (URL) accessible for the converted storytelling data. Further, the storytelling data providing apparatus 100 may encrypt and store the generated URL. The encrypted URL may have a predetermined valid duration. Therefore, when the predetermined valid duration elapses, even though the encrypted URL is decrypted, the storytelling data is not accessible with the decrypted URL.

The storytelling data providing apparatus 100 may perform user encryption for the storytelling data consuming terminal 300 in response to an access request from the storytelling data consuming terminal 300. When the storytelling data consuming terminal 300 is authenticated, the storytelling data providing apparatus 100 may return the accessible encrypted URL of the storytelling data to the storytelling data consuming terminal 300 based on user information about the storytelling data consuming terminal 300.

The storytelling data consuming terminal 300 may decrypt the encrypted URL based on the user information and access the storytelling data by using the decrypted URL. Because the decrypted URL is the address of the storytelling data converted to the format (e.g., html or pdf) openable by a known application, the storytelling data consuming terminal 300 may easily open the storytelling data without the need for installing Jupyter. Further, an unauthorized storytelling data consuming terminal 300 may be blocked from accessing or editing the storytelling data.

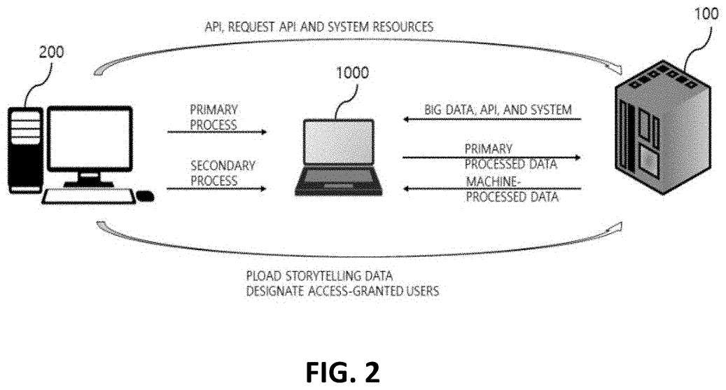

FIG. 2 is a conceptual view partially illustrating an operational relationship between the storytelling data creating terminal and the storytelling data providing apparatus illustrated in FIG. 1.

Referring to FIG. 2, the storytelling data creating terminal 200 may request an API and system resources to the storytelling data providing apparatus 100. The storytelling data providing apparatus 100 may generate the virtual machine 1000 according to the requested system resources and add an available API to the generated virtual machine 1000. Further, the storytelling data providing apparatus 100 may configure pre-collected big data to be accessible to the virtual machine 1000.

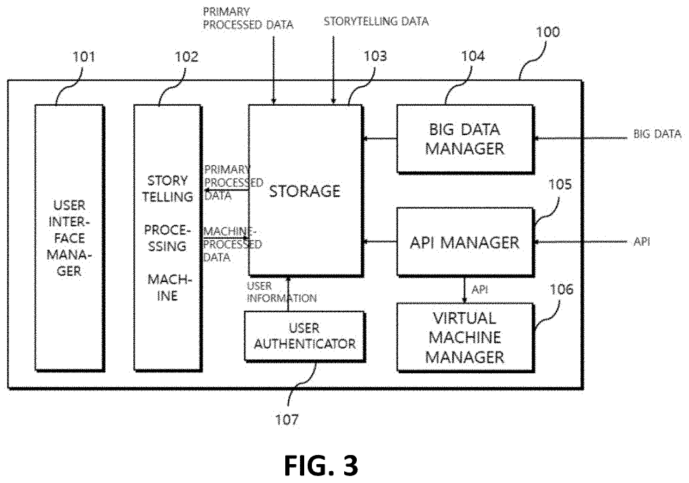

The storytelling data creating terminal 200 may generate primary processed data by primarily processing the big data by using the virtual machine 1000 and store the generated primary processed data. The storytelling data providing apparatus 100 may obtain the stored primary processed data and process the primary processed data by using a storytelling processing machine (see FIG. 3) to generate machine-processed data.

The machine-processed data may be data obtained by adding a visualized image and new text based on the primary processed data and changing a storyline. According to an embodiment of the present disclosure, the storytelling data providing apparatus 100 may generate the machine-processed data and provide the machine-processed data to the storytelling data creating terminal 200, thereby supporting creation of storytelling data with a higher quality.

The storytelling data creating terminal 200 may be supported to open the machine-processed data through the virtual machine 1000.

The storytelling data creating terminal 200 may open the machine-processed data through the virtual machine 1000 and secondarily process the machine-processed data by correcting errors or amending items which are not to be reflected in the opened machine-processed data, to finally generate the storytelling data.

The storytelling data creating terminal 200 may upload the storytelling data to the storytelling data providing apparatus 100. Herein, the storytelling data creating terminal 200 may designate access-granted users for the storytelling data.

The storytelling data providing apparatus 100 may perform access authentication on the storytelling data consuming terminal 300, for the storytelling data, referring to the access-granted users.

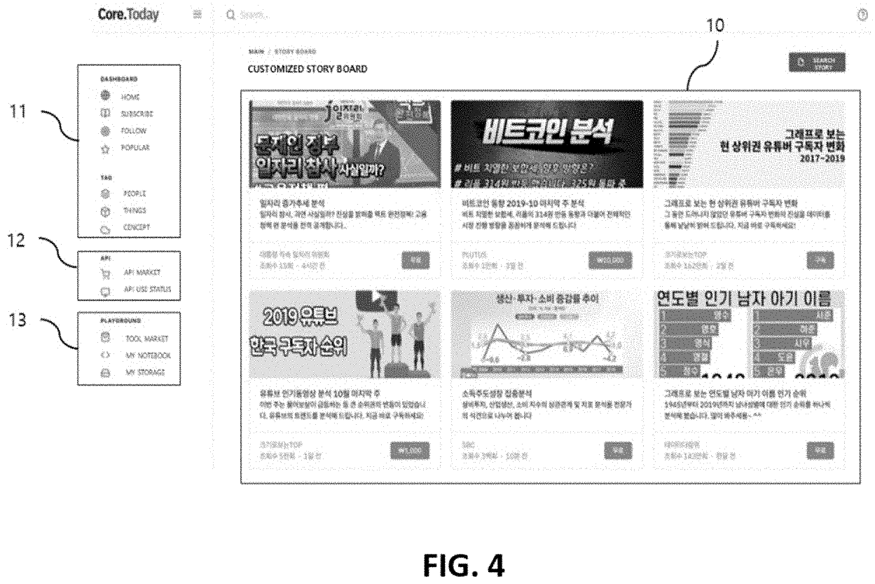

FIG. 3 is a conceptual view illustrating functional blocks of the storytelling data providing apparatus illustrated in FIG. 1. FIG. 4 is an exemplary diagram illustrating a user interface provided by the storytelling data providing apparatus illustrated in FIG. 1.

Referring to FIG. 3, the storytelling data providing apparatus 100 may include a user interface manager 101, a storytelling processing machine 102, a storage 103, a big data manager 104, an API manager 105, a virtual machine manager 106, and a user authenticator 107.

The user interface manager 101 may generate a Web browser-based user interface and provide the generated user interface to the storytelling data creating terminal 200 and the storytelling data consuming terminal 300.

For example, referring to FIG. 4, the Web browser-based user interface may include a story board 10 displaying multiple storytelling data, a dash board 11 including a list of creators which are subscribed to or followed, for sharing storytelling data, a list of popular creators, and a list of storytelling data classified by tags assigned to the respective storytelling data, which may be read by operating a specific storytelling data creating terminal 200, an API market 12 in which the storytelling data creating terminal 200 may purchase and share an API available to the virtual machine 1000, and a virtual machine management list 13 in which the storytelling data creating terminal 200 may open and edit the resources of its virtual machine 1000 and a Notebook document worked on with the virtual machine 1000.

Referring to FIG. 3 again, the storytelling processing machine 102 may obtain primary processed data stored in the storage 103, generate machine-processed data by re-processing the primary processed data based on big data stored in the storage 103, and store the generated machine-processed data in the storage 103. For example, the storytelling processing machine 102 may collect text and images from the primary processed data and additionally collect images highly correlated with the collected text and text highly correlated with the collected images from the big data. Further, the storytelling processing machine 102 may re-process the primary processed data based on the additionally collected images and text.

The storytelling processing machine 102 may be, but not limited to, a virtualization machine running an algorithm that executes the above-described functions or a virtualization machine with a deep learning-based algorithm embedded therein. The story processing machine 102 may be software implemented in machine code executable in the storytelling data providing apparatus 100 or in various programming languages including Python.

The storage 103 may store the primary processed data uploaded from the storytelling data creating terminal 200 and storytelling data as a final product, or may store machine-processed data output from the storytelling processing machine 102. Further, the storage 103 may store big data collected through the big data manager 104. For example, the storage 103 may be a Hadoop distributed file system (HDFS).

The big data manager 104 may receive big data collected in a Web-based environment through Web crawling or the like or in any other manner, store the received big data in the storage 103, and provide the big data to an authenticated virtual machine 1000.

The API manager 105 may receive APIs collected in various manners, store the received APIs in the storage 103, and provide an API to the authenticated virtual machine 1000 by purchase.

The virtual machine manager 106 may generate a plurality of virtual machines available to the storytelling data creating terminal 200 and manage access authority to the system resources of the generated virtual machines, the APIs, and so on.

The user authenticator 107 may store user information about the storytelling data consuming terminal 300 and the storytelling data creating terminal 200 in the storage 103, and perform user authentication for the storytelling data consuming terminal 300 and the storytelling data creating terminal 200 based on the user information. For example, the user authenticator 107 may perform user authentication for a user of the storytelling data consuming terminal 300 and provide an encrypted URL of the storytelling data to the authenticated storytelling data consuming terminal 300.

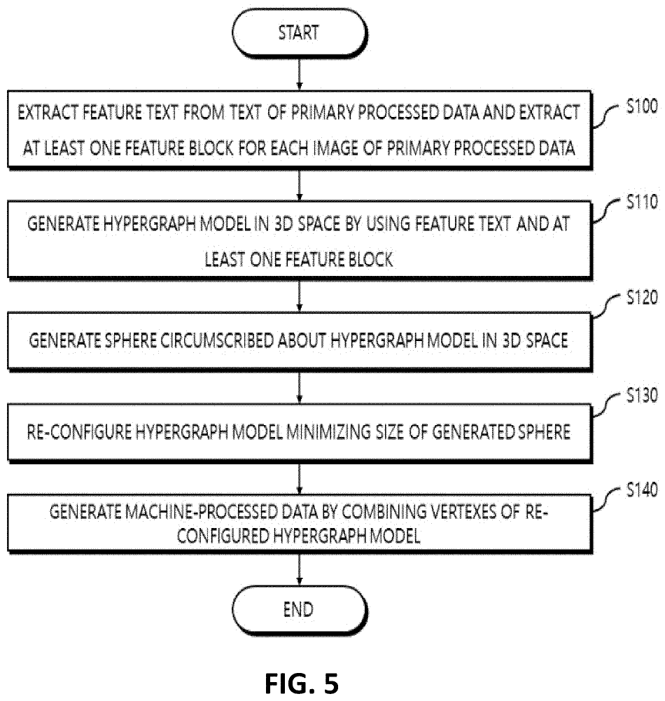

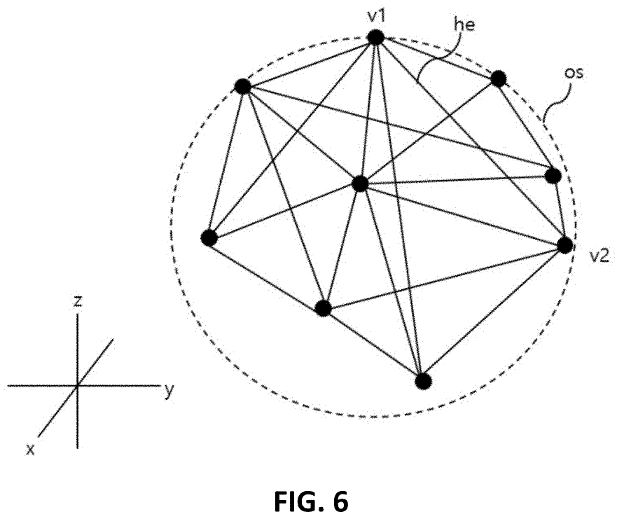

FIG. 5 is a flowchart illustrating a process of creating machine-processed data, performed by the storytelling processing machine illustrated in FIG. 3. FIG. 6 is a conceptual view illustrating a hypergraph model according to an embodiment of the present disclosure.

Referring to FIG. 5, the storytelling processing machine 102 may first extract feature text from text of primary processed data and then at least one feature block for each of images of the primary processed data (S100).

For example, the feature text may be obtained by excluding verbs, adjectives, adverbs, and nouns having ordinary meanings (e.g., words, data, something, things, and so on) and extracting the remaining nouns, based on semantic analysis of the text of the primary processed data.

A feature block may be extracted in each image of the primary processed data. For example, a feature block may be extracted in a first image of the primary processed data in the following process.

First, the first image may be realized in a three-dimensional (3D) space, using first and second axes defining the position coordinates of pixels of the first image and a third axis representing pixel values of the first image. In the 3D space, the position of each pixel of the first image may be on a plane defined by the first and second axes, and a height corresponding to a pixel value at the position of each pixel may be a coordinate value on the third axis.

Maximum and minimum values for the third axis may then be detected in the 3D space. The maximum and minimum values may be the positions of convex and concave pixels along the third axis in the 3D space.

Subsequently, at least one feature block may be extracted for the first image by extracting a predetermined area defined along the first and second axes with respect to the detected maximum and minimum values.

Once the feature text and the feature blocks are extracted, the storytelling processing machine 102 may generate a hypergraph model in the 3D space, using the feature text and at least one feature block (S110). The hypergraph model may be a graph model in which one edge is referred to as a hyper edge connectable to three or more vertexes at the same time. The hypergraph model may be useful in plotting associations among factors having complicated connections to one another into one graph.

In an embodiment of the present disclosure, the hypergraph model may have a combination of feature text and at least one feature block of an image adjacent to the feature text as one vertex v1 or v2, and a hyper edge he connecting the vertexes to each other. The length of the hyper edge he may be a distance in the 3D space, which is shorter for a higher correlation between the two vertexes.

For example, when a value calculated by multiplying the reciprocal of a probability of two vertexes appearing in the same document by a predetermined first proportional constant is defined as an x axis, a value calculated by multiplying a second proportional constant by the physical distance between the two vertexes on the assumption that the two vertexes appear in the same document is defined as a y axis, and a semantic distance between the two vertexes is defined as a z axis, a distance in the 3D space may be a distance represented by the x, y, and z axes.

The probability of the two vertexes, which are required to define the x axis, appearing in the same document may be a value calculated by dividing the number of all documents included in big data stored in the storage 103 by the number of documents in which the two vertexes appear at the same time.

The physical distance between the two vertexes which are assumed to appear in the same document may be determined in the following manner. For example, the physical distance between a first vertex v1 and a second vertex v2 may be the average of a distance between the feature text of the first vertex v1 and the feature text of the second vertex v2 and a distance between at least one feature block of the first vertex v1 and at least one feature block of the second vertex v2. The physical distance may be defined as one of the numbers of sentences, paragraphs, and words between the first vertex v1 and the second vertex v2.

For example, the distance between the feature text of the first vertex v1 and the feature text of the second vertex v2 may be defined as one of the numbers of sentences, paragraphs, and words which appear between the feature text of the first vertex v1 and the feature text of the second vertex v2 in the same document A. Similarly, the distance between at least one feature block of the first vertex v1 and at least one feature block of the second vertex v2 may be defined as one of the numbers of sentences, paragraphs, and words which appear between the at least one feature block of the first vertex v1 and the at least one feature block of the second vertex v2 in the same document A.

The semantic distance between the two vertexes may be defined as follows. For example, the semantic distance between the first vertex v1 and the second vertex v2 may be determined by averaging a first distance calculated based on identicalness in terms of technical field, linguistic semantics, and occurrence time between the feature text of the first vertex v1 and the feature text of the second vertex v2 and a second distance representing an image similarity between at least one feature block of the first vertex v1 and at least one feature block of the second vertex v2.

For example, whether the two feature texts are identical in their technical fields, whether the two feature texts are similar or identical in their semantics, and whether the generation dates of documents in which the two feature texts appear are similar are evaluated numerically to determine the first distance between the feature text of the first vertex v1 and the feature text of the second vertex v2.

Further, regarding the image similarity between the at least one feature block of the first vertex v1 and the at least one feature block of the second vertex v2, the at least one feature block of the first vertex v1 may be mapped to the at least one feature block of the second vertex v2, a differential block may be generated by calculating the differences between the pixel values of the two mapped feature blocks, and the image similarity may be defined as the reciprocal of the average of the pixel values of the differential block. The second distance may be determined by multiplying the thus-defined image similarity by a predetermined transformation constant.

As described before, the length of a hyper edge connecting two vertexes to each other is determined to be shorter for a higher correlation between the two vertexes in the hypergraph model in the 3D space. Therefore, as the correlation between vertexes in the hypergraph model increases, the area occupied by the vertexes decreases in the 3D space.

The storytelling processing machine 102 may generate a sphere os circumscribed about the hypergraph model in the 3D space by evaluating the hypergraph model based on this property (S120).

As the size of the generated sphere os is smaller, the storytelling data may be made up of highly correlated text and images. Accordingly, the storytelling processing machine 102 may re-configure the hypergraph model in a manner that minimizes the size of the generated sphere os (S130). For example, the storytelling processing machine 102 may replace feature text included in at least one of the vertexes of the hypergraph model with text which appears in the same document and which is adjacent in terms of a physical distance in the document. Similarly, the storytelling processing machine 102 may replace at least one feature block included in at least one of the vertexes of the hypergraph model with at least one feature block of an image which appears in the same document as the at least feature block and which is adjacent in terms of a physical distance in the document.

Therefore, the storytelling processing machine 102 may re-configure the hypergraph model with a smallest sphere os by repeating the step S130 of re-configuring the hypergraph model. Subsequently, the storytelling processing machine 102 may generate machine-processed data by combining the vertexes of the re-configured hypergraph model (S140).

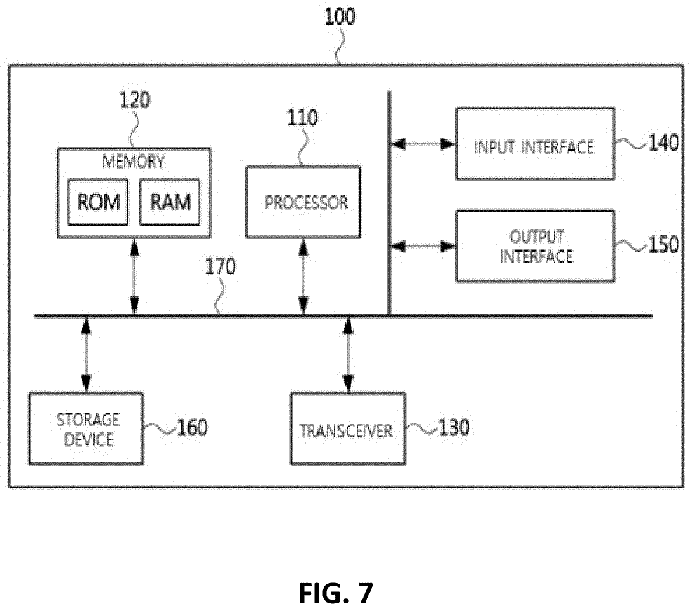

FIG. 7 is a block diagram illustrating an exemplary hardware configuration of the storytelling data providing apparatus illustrated in FIG. 1.

Referring to FIG. 7, the storytelling data providing apparatus 100 may include at least one processor 110 and a memory 120 storing instructions which instruct the at least one processor 110 to perform at least one step.

The at least one processor 110 may be a central processing unit (CPU), a graphics processing unit (GPU), or a dedicated processor performing the methods according to embodiments of the present disclosure. Each of the memory 120 and a storage device 160 may include at least one of a volatile storage medium or a non-volatile storage medium. At least one of the memory 120 or the storage device 160 may correspond to the storage 103 illustrated in FIG. 3. For example, the memory 120 may include at least one of a read only memory (ROM) or a random access memory (RAM).

Further, the storytelling data providing apparatus 100 may include a transceiver 130 performing communication through a wireless network. The storytelling data providing apparatus 100 may further include an input interface 140, an output interface 150, and the storage device 160. The components of the storytelling data providing apparatus 100 may be interconnected by a bus 170 and perform communication.

The at least one step may include receiving a message requesting an API and system resources from the storytelling data creating terminal 200, generating the virtual machine 1000 according to the system resources, adding the API to the virtual machine 1000 and configuring pre-collected big data to be accessible to the virtual machine 1000; obtaining primary processed data from the storytelling data creating terminal 200, generating machine-processed data by processing the primary processed data by using the storytelling processing machine 102, and providing the machine-processed data to the storytelling data creating terminal 200, and obtaining storytelling data generated based on the machine-processed data from the storytelling data creating terminal 200.

The at least one step may further include converting the storytelling data to a format openable by a known application, and generating a URL accessible for the converted storytelling data.

After the generation of the URL accessible for the converted storytelling data, the at least one step may further include receiving a message requesting access from a storytelling data consuming terminal, performing user authentication for the storytelling data consuming terminal, and encrypting the URL and providing the encrypted URL to the storytelling data consuming terminal in response to completion of the user authentication.

The virtual machine may be Jupyter Notebook being a Python-based development tool.

The storytelling processing machine may perform the steps of, by using the at least one processor, generating a hypergraph model based on the primary processed data, and generating the machine-processed data by repeating a process of re-configuring the hypergraph model.

The storytelling data providing apparatus 100 may be any of, for example, a communication-enabled desktop computer, a laptop computer, a notebook, a smartphone, a tablet PC, a mobile phone, a smartwatch, smart glasses, an e-book reader, a portable multimedia player (PMP), a portable game console, a navigation device, a digital camera, a digital multimedia broadcasting (DMB) player, a digital audio recorder, a digital audio player, a digital video recorder, a digital video player, a personal digital assistant (PDA), and so on.

The method according to the present disclosure may be implemented in the form of program commands executable in various computer means and recorded in a computer-readable medium. The computer-readable medium may include program commands, data files, data structures, and so on, alone or in combination. The program commands recorded on the computer-readable medium may be designed and configured specially for the present disclosure or known and available to those skilled in computer software.

The computer-readable medium may include any kind of hardware device configured specially to store and execute program commands, such as a ROM, RAM, and a flash memory. The program commands may include, for example, a premium language code that can be executed in a computer using an interpreter as well as a machine code produced by a compiler. The above-mentioned hardware device may be implemented as one or more software modules to perform the operations of the present disclosure, and vice versa.

Further, the afore-described method or apparatus may be implemented with all or a part of its components or functions in combination or separated from each other.

While reference has been made above to preferred embodiments of the present disclosure, those skilled in the art will understand that various modifications and variations can be made to the present disclosure without departing from the scope and spirit of the present disclosure defined by the appended claims.

1. An apparatus for providing storytelling data, the apparatus comprising:
at least one processor; and
a memory storing instructions instructing the at least one processor to perform at least one step,
wherein the at least one step includes:
receiving a message requesting an application programming interface (API) and system resources from a storytelling data creating terminal;
generating a virtual machine according to the system resources;
adding the API to the virtual machine and configuring pre-collected big data to be accessible to the virtual machine;
obtaining primary processed data from the storytelling data creating terminal;
generating machine-processed data by processing the primary processed data by using a storytelling processing machine; and
providing the machine-processed data to the storytelling data creating terminal, and obtaining storytelling data generated based on the machine-processed data from the storytelling data creating terminal.

2. The apparatus according to claim 1, wherein the at least one step further includes:
converting the storytelling data to a format openable by a known application; and
generating a uniform resource locator (URL) accessible for the converted storytelling data.

3. The apparatus according to claim 2, wherein after the generation of the URL accessible for the converted storytelling data, the at least one step further includes:
receiving a message requesting access from a storytelling data consuming terminal;
performing user authentication for the storytelling data consuming terminal; and
encrypting the URL and providing the encrypted URL to the storytelling data consuming terminal, in response to completion of the user authentication.

4. The apparatus according to claim 1, wherein the virtual machine is Jupyter Notebook being a Python-based development tool.

5. The apparatus according to claim 1, wherein the storytelling processing machine performs, by using the at least one processor, the steps of:
generating a hypergraph model based on the primary processed data; and
generating the machine-processed data by repeating a process of re-configuring the hypergraph model.
